(19) United States
(12) Patent Application Publication
(10) Pub. No.: US 2026/0113098 A1
(43) Pub. Date: Apr. 23, 2026

(54) ANTENNA SYSTEM, ELECTRONIC WEARABLE DEVICE AND METHOD FOR CONTROLLING ANTENNA SYSTEM

(71) Applicant: Goertek Inc., Weifang, Shandong (CN)

(72) Inventor: HIROTADA TANIUCHI, Shandong (CN)

(73) Assignee: Goertek Inc., Weifang, Shandong (CN)

(21) Appl. No.: 19/115,945

(22) PCT Filed: Dec. 6, 2022
(86) PCT No.: PCT/CN2022/136782

§ 371 Date: Mar. 27, 2025

(51) Int. Cl. H04B 7/06; H01Q 1/27; H01Q 3/24; H04B 7/08

(52) U.S. Cl. CPC H04B 7/0691; H01Q 1/273; H01Q 3/24; H04B 7/0802

(57) ABSTRACT

An antenna system, an electronic wearable device, and a method for controlling an antenna system are provided. The antenna system includes: multiple antennas, and a switch module configured to selectively connect the multiple antennas to at least one first port and multiple second ports of a transceiver. Each of the plurality of antennas is selectively connected to the at least one first port to receive and transmit wireless signals, and each of the antennas is selectively connected to at least one of the plurality of second ports via the switch module to receive the wireless signals.

This application is a National Stage of International Application No. PCT/CN2022/136782, filed on Dec. 6, 2022, which is hereby incorporated by reference in its entirety.

### TECHNICAL FIELD

The present disclosure relates to the technical field of electronic devices, and in particular, to an antenna system, an electronic wearable device and a method for controlling an antenna system.

### BACKGROUND

Recent decades have witnessed prosperity of electronic wearable devices. Being designed properly, these devices are generally not handheld during usage, but are “worn” as accessories or even apparel on body parts of a user, i.e. a wearer. Hence, it is quite convenient for the wearer to interact with the outside world simultaneously in various manners. For example, a wireless hands-free head worn headset computing device includes a display device and a spatially diverse antenna system. The spatially diverse antenna system provides a radiation pattern for the head worn headset computing device, by which the user can arbitrarily move.

In addition, the virtual reality (VR) or augmented reality (AR) technology may apply electronic headwear to provide visual and/or acoustic information, while the wearer is able to operate a keyboard or a gamepad by hand. For another example, an electronic wristband may collect electro-cardio signals of the wear, while not interrupting daily activities of the wearer. For another example, electronic glasses may prompt the wearer with detailed content of instant messages, even when both bands of the wearer are occupied.

Rapid development of the integrated circuits renders electronic wearable devices smaller sizes and more compact structures, which aims at merging them into each application scenario in people's daily life. Therefore, an increasing requirement on convenient “anytime and anywhere” accesses to the Internet and WLANs demands the electronic wearable devices wireless and portable. A prospect is that the electronic wearable devices are capable to provide high-quality wireless accesses regardless the location and direction of the user relative to the electronic wearable device. Such objective raises great challenges on a robust design of the electronic wearable devices.

### SUMMARY

In view of the above, an antenna system, an electronic wearable device and a method for controlling an antenna system are provided according to embodiments of the present disclosure, to improve transmitter performance of the antenna.

Following technical solutions are provided to achieve the above technical objective.

In a first aspect, an antenna system is provided according to an embodiment of the present disclosure. The antenna structure includes multiple antennas; and a switch module configured to selectively connect the multiple antennas to at least one first port and a plurality of second ports of a transceiver. Each of the multiple antennas is selectively connected to the first port via the switch module to receive and transmit wireless signals, and each of the plurality of antennas is selectively connected to at least one of the multiple second ports via the switch module to receive wireless signals.

In a second aspect, an electronic wearable device is provided according to an embodiment of the present disclosure. The electronic wearable device includes a transceiver comprising at least one first port and multiple second ports, wherein the first port is connected to both a transmitter and a receiver in the transceiver, and the second port is connected to the receiver in the transceiver; and an antenna system. The antenna system includes: multiple antennas: the switch module configured to selectively connect the multiple antennas to the at least one first port and the multiple second ports of the transceiver. Each of the multiple antennas is selectively connected to the first port via the switch module to receive and transmit wireless signals, and each of the plurality of antennas is selectively connected to at least one of the multiple second ports via the switch module to receive the wireless signals.

In a third aspect, a method for controlling an antenna system is provided according to an embodiment of the present disclosure. The antenna system includes multiple antennas. The method includes: measuring receiver levels of the multiple antennas; and selectively connecting the multiple antennas to at least one first port and multiple second ports of a transceiver based on the determined receiver levels of the multiple antennas. Each of the multiple antennas is selectively connected to the first port to receive and transmit wireless signals, and each of the plurality of antennas is selectively connected to at least one of the multiple second ports via a switch module to receive wireless signals.

The antenna system, the electronic wearable device and the method for controlling the antenna system are provided according to embodiments of the present disclosure. The antenna structure includes multiple antennas, and a switch module configured to selectively connect the multiple antennas to at least one first port and multiple second ports of a transceiver. Each of the multiple antennas is selectively connected to the first port via the switch module to receive and transmit wireless signals. Each of the plurality of antennas is selectively connected to at least one of the multiple second ports via the switch module to transmit and receive wireless signals. In the antenna system, each antenna can be selectively connected to the first port. In this way, the antenna with best communication quality can be selected to connect to the first port. Thus, the quality of wireless communication will not depend on the location and direction of the user. The transmitter performance of the antenna is improved, so as to improve uplink data communication via wireless communication system with low power consumption.

### BRIEF DESCRIPTION OF THE DRAWINGS

For clearer illustration of the technical solutions according to embodiments of the present disclosure or conventional techniques, hereinafter briefly described are the drawings to be applied in embodiments of the present disclosure or conventional techniques. Apparently, the drawings in the following descriptions are only some embodiments of the present disclosure, and other drawings may be obtained by those skilled in the art based on the provided drawings without creative efforts.

FIG. 1 is a diagram of a wireless communication performance of a conventional mobile device;

FIG. 2 is a diagram of a wireless communication performance of a conventional mobile device;

FIG. 3 is a block diagram of a radio frequency front-end in a conventional mobile device;

FIG. 4 is a block diagram of a RF front-end in a conventional mobile device;

FIG. 5 a block diagram of a transceiver for a wireless communication system in a conventional mobile device;

FIG. 6 is a diagram of radiation pattern of antenna in a conventional mobile device;

FIG. 7 is a diagram of an antenna system according to an embodiment of the present disclosure;

FIGS. 8a-8d are diagrams of radiation patterns of different antennas connected to a first port according to an embodiment of the present disclosure;

FIG. 9 is a diagram of a structure of a switch module according to an embodiment of the present disclosure;

FIG. 10 is a diagram of a structure of a switch module according to another embodiment of the present disclosure;

FIG. 11 is a diagram of a switch module in time domain technology according to an embodiment of the present disclosure;

FIG. 12 is a diagram of an electronic wearable device according to an embodiment of the present disclosure;

FIGS. 13a-13f are diagrams of examples of an electronic wearable device according to an embodiment of the present disclosure; and

FIG. 14 is a flow chart of a method of controlling an antenna system according to an embodiment of the present disclosure.

### DETAILED DESCRIPTION OF EMBODIMENTS

Hereinafter technical solutions in embodiments of the present disclosure are described in conjunction with the drawings in embodiments of the present closure. The described embodiments are only some rather than all of the embodiments of the present disclosure. Any other embodiments obtained based on the embodiments of the present disclosure by those skilled in the art without any creative effort fall within the scope of protection of the present disclosure.

It should be noted that, the relationship terms such as “first”. “second” and the like are only used herein to distinguish one entity or operation from another, rather than to necessitate or imply that an actual relationship or order exists between the entities or operations. Furthermore, the terms such as “include”, “comprise” or any other variants thereof means to be non-exclusive. Therefore, a process, a method, an article or a device including a series of elements include not only the disclosed elements but also other elements that are not clearly enumerated, or further include inherent elements of the process, the method, the article or the device. Unless expressively limited, the statement “including a . . . ” does not exclude the case that other similar elements may exist in the process, the method, the article or the device other than enumerated elements.

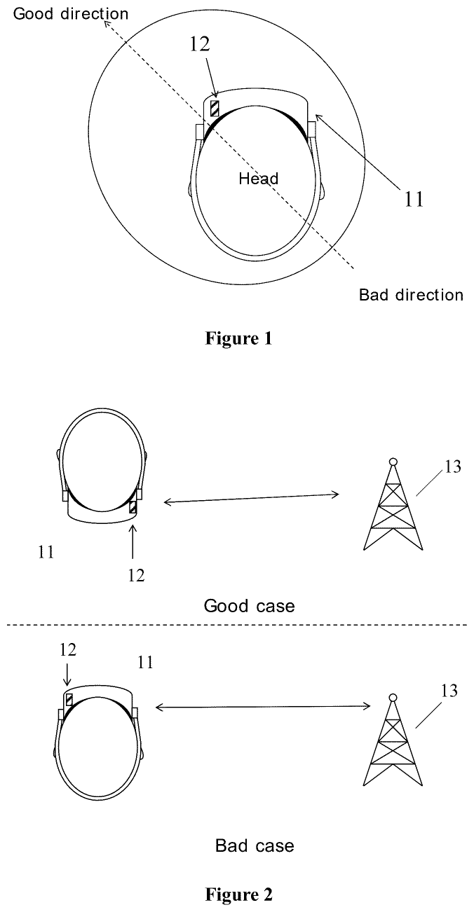

In an embodiment of the present disclosure, a mobile device may be, but is not limited to, an AR goggle, a VR goggle, ear buds, a smart watch, a smart glass or a smart belt. In an embodiment, a smart glass is taken as example, as shown in FIG. 1. FIG. 1 is a diagram of a wireless communication performance of a conventional mobile device. In FIG. 1, smart glasses 11 are worn by a user, which includes an antenna 12. Radiation pattern of the antenna 12 for the smart glass 11 is designed omni-directional to keep good wireless connectivity regardless positions, directions and motion of the device and user. However, the radiation pattern of the smart glass 11 tends to be directional. That is because a body of the user absorbs radio frequency (RF) wave and works as an obstacles to RF wave. As shown in FIG. 1, better performance of the antenna is shown on a side opposite to human body of the user and worse performance of the antenna is shown on a human body side. Thus, in the conventional mobile device, the quality of wireless communication depends on the locations of the user relative to the mobile device.

FIG. 2 is a diagram of a wireless communication performance of a conventional mobile device. In FIG. 2, the mobile device, such as the smart glasses 11 with the antenna 12, is worn by a user. The smart glasses 11 transmit and receive signals through a base station 13. When the base station 13 is located at a side close to the antenna 12 of the user, the communication quality of the mobile device is good. When the base station is located at a side opposite to the antenna 12 of the user, the communication quality of the mobile device is poor. Therefore, the quality of wireless communication of the mobile device depends on the directions of the mobile device relative to the base station.

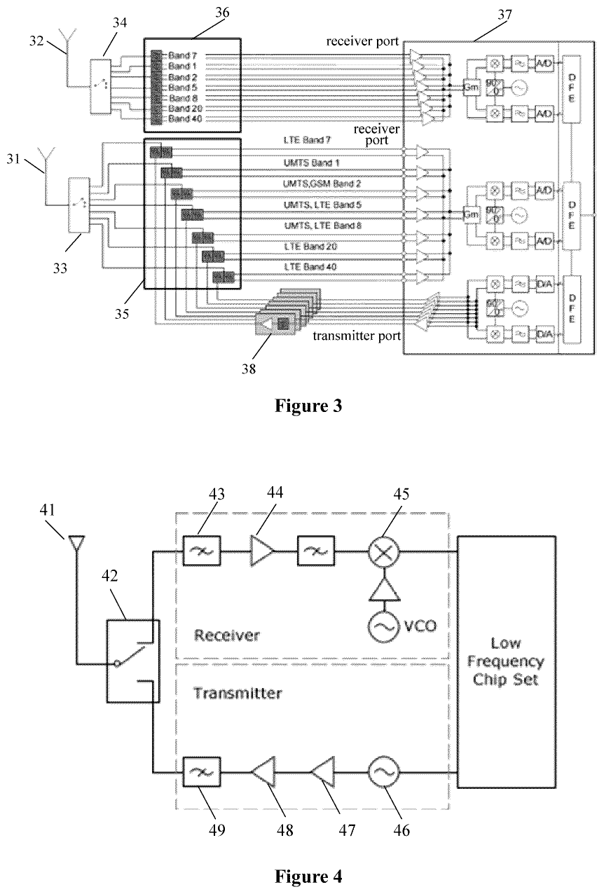

It should be noted that the mobile device may be operated in various wireless communication protocols. For example, the mobile device may be operated in Long-Term Evolution (LTE). Universal Mobile Telecommunications Service (UMTS) or wireless local area network protocols (e.g., IEEE 802.11 protocols, referred to as WiFi®). A structure of the radio frequency (RF) front-end in the mobile device is shown as an example in FIG. 3. FIG. 3 is a block diagram of a radio frequency (RF) front-end in a conventional mobile device. In an embodiment, the RF front-end is operated in multi-band LTE or UMTS. As shown in FIG. 3, an antenna 31 is selectively connected to each frequency band of a transmitter block by a switch 33. The antenna 31 is respectively connected to the receiver ports and the transmitter ports by a duplexer 35 to receive and transmit the signals. The transmitted signal and the received signal are isolated by the duplexer 35. The received signal is filtered by a band path filter 36 and received by a receiver port in the transceiver IC 37. The transmitted signal is transmitted by the transceiver IC 36 and amplified by a power amplifier 38. The antenna 32 is connected to respective frequency bands of diversity block by a switch 34 to provide the received signal to the receiver port on the transceiver IC. Noise signal in the received signal is rejected by the band path filter 36.

FIG. 4 is a block diagram of a RF front-end in a conventional mobile device. In an embodiment, the RF front-end is a WiFi front-end device. The antenna 41 is respectively connected to the receiver port and the transmitter port by a single pole double throw switch 42 to receive and transmit the signals. The single pole double throw switch 42 functions as a duplexer. The received signal is filtered by a filter 43, amplified by a low-noise amplifier 44, and then converted to a local signal by a mixer 45. The transmitted signal is converted by a voltage-controlled oscillator 46, amplified by a driver 47 and a power amplifier 48, and then filtered by a filter 49.

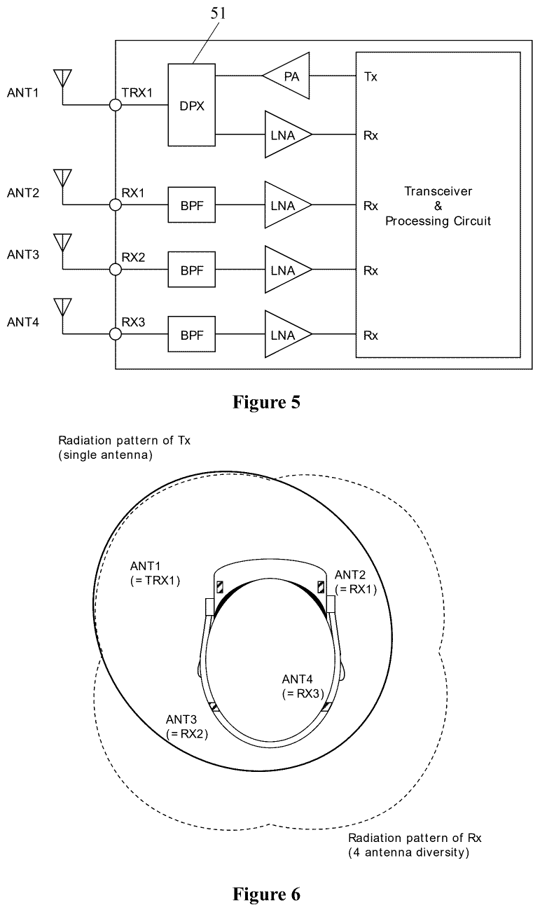

FIG. 5 is a block diagram of a transceiver for a wireless communication system in a conventional mobile device. For implementing a high data rate by a multiple-input and multiple-output system and a stable network connection by a diversity system, the mobile device has two or more receiver ports, and two or more antennas for the receiver ports. In addition, the mobile device has at least one transmitter port, and an antenna for the transmitter port. Usually, the number of transmitter port is smaller than the number of the receiver ports. That is because consumption of the transmitter is much higher than the receiver. For example, as shown in FIG. 5, four antennas ANT1, ANT2, ANT3 and ANT4 are provided. The antenna ANT1 is connected to the transmitter port TX and a receiver port RX via the duplexer 51. The other antennas ANT2, ANT3 and ANT4 are respectively connected to the receiver ports RX.

FIG. 6 is a diagram of radiation pattern of antenna in a conventional mobile device. FIG. 6 shows the radiation pattern of wireless communication system shown in FIG. 5. When the antennas ANT1, ANT2, ANT3 and ANT4 are all connected to the receiver ports RX, omni-directional radiation pattern is shown by a dotted line in FIG. 6. The radiation pattern can be configured by a combination of four antennas which have different directions of radiation pattern. When the antennas ANT1 is connected to the transmitter port Tx and the antennas ANT2, ANT3 and ANT4 are connected to receiver ports RX, the number of antenna is smaller than the number of the receiver ports. The radiation pattern is shown by a solid line in FIG. 6. Obviously, the communication quality at the side opposite to human body of the user is better than that at the human body side. Thus, the quality of wireless communication still depends on the locations and directions of the user relative to the mobile device.

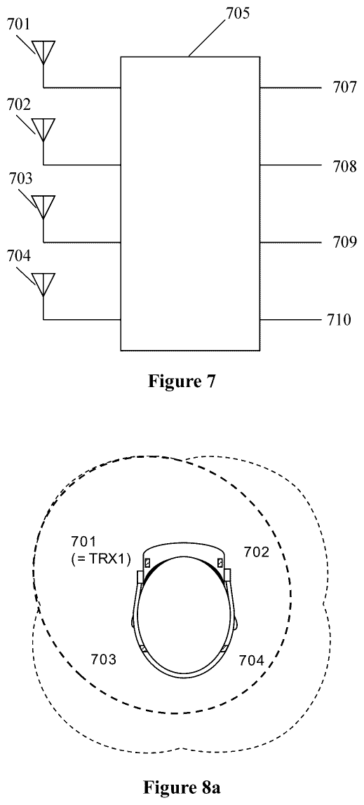

In an embodiment, an antenna system is provided, as shown in FIG. 7. FIG. 7 is a diagram of an antenna system according to an embodiment of the present disclosure. The antenna structure 700 includes multiple antennas 701, 702, 703 and 704; and a switch module 705 configured to selectively connect the multiple antennas 701, 702, 703 and 704 to at least one first port 707 and multiple second ports 708, 709 and 710 of a transceiver. Each of the multiple antennas 701, 702, 703 and 704 is selectively connected to the first port 707 via the switch module 705 to receive and transmit wireless signals. Each of the plurality of antennas is selectively connected to at least one of the multiple second ports 708, 709 and 710 via the switch module 705 to transmit the wireless signals.

In FIG. 7, four antennas are shown as an example. Actually, the mobile device usually has 2 or more receiver antennas for Rx diversity and downlink (DL) of the Multi-Input and Multi-Output (MIMO) system. Due to power consumption of transmitter much bigger than that of the receiver, the number of transmitter is smaller than the number of receiver generally. In the case of 5G New Radio (5G NR), the mobile device includes four receiver antennas for 4×4 DL MIMO, and one transmitter antenna for Uplink (UL) MIMO. It should be noted that any number of antennas are within the scope of this application, as long as the number of antennas is equal to or more than 2. Furthermore, three second ports and one first port are shown in FIG. 7. In an embodiment, the number of second ports is equal to or more than 2. The number of first port is equal to or larger than one, and equal to or smaller than the number of second ports.

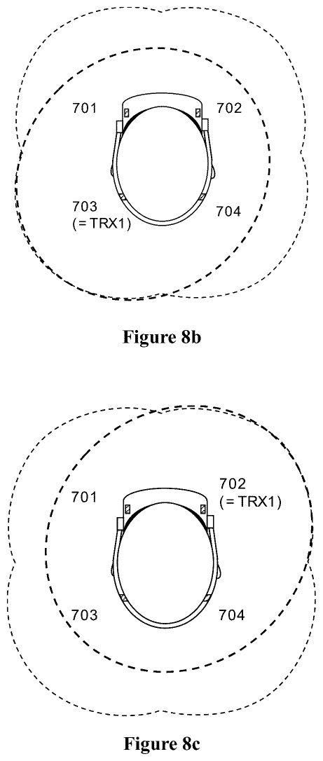

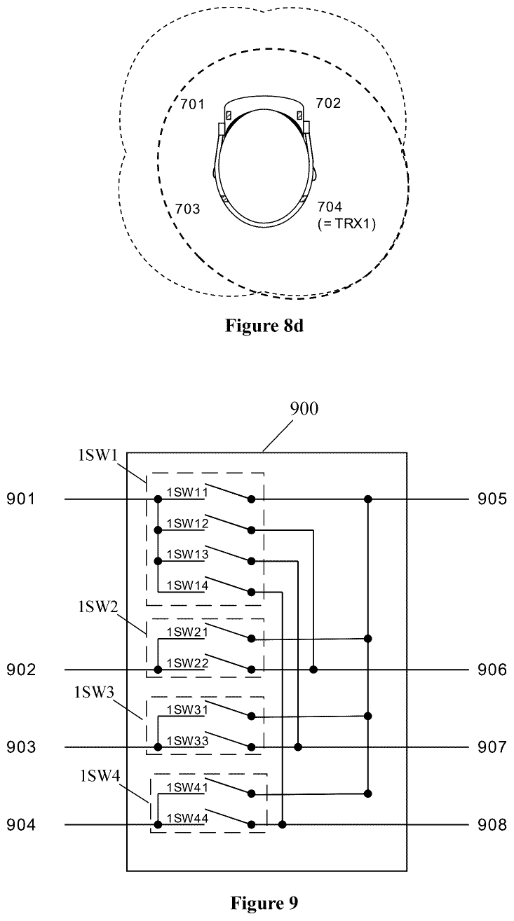

FIGS. 8a-8d are diagrams of radiation patterns of different antennas connected to a first port according to an embodiment of the present disclosure. As shown in FIGS. 8a-8d, the antennas 701, 702, 703 and 704 are separately arranged on the electronic wearable device around the head of the user. FIG. 8a shows a radiation pattern of the antenna 701 which is connected to the first port 707 which is shown as TRX1 in FIG. 8a-8d. FIG. 8b shows a radiation pattern of the antenna 703 which is connected to the first port 707. FIG. 8c shows a radiation pattern of the antenna 702 which is connected to the first port 707. FIG. 8d shows a radiation pattern of the antenna 704 which is connected to the first port 707. Based on the antenna system according to the embodiment of the present disclosure, a good communication quality can be obtained in all directions by selectively connecting at least one of antennas to the first port. Thus, the quality of wireless communication does not depend on the locations and directions of the user and the mobile device by connecting different antennas to the first port.

In an embodiment, a structure of the switch module is described in combination with FIG. 9. In an embodiment, it is assumed that the number of antennas is M, the number of second ports is N, and the number of first port is K, wherein M is an integer larger than or equal to 2, N is an integer larger than or equal to 2. K is larger than or equal to 1, and the number of second ports is equal to or larger than the number of the first port. In this case, the above antenna module may include: one set of single pole N throw switch, and (M−1) set of single pole double throw switches.

The single pole N throw switch includes an input terminal connected to an antenna of the multiple antennas, and output terminals respectively connected to the multiple second ports and the first port. That is, the single pole N throw switch is used to connect one of the antennas to the first port and the multiple second ports.

Each of the single pole double throw switches includes an input terminal connected to the other antenna of the multiple antennas, except the antenna connected with the input terminal of the single pole N throw switch, and output terminals respectively connected to the first port and one of the multiple second ports. That is, each single pole double throw switch is used to connect one antenna to the first port and one second port.

Each antenna can be selectively connected to the first port through the switch module according to the embodiments of the present disclosure. Thus, a good communication quality can be obtained in all directions, such that the quality of wireless communication does not depend on the locations and directions of the user and the mobile device.

In an implementation of the present disclosure, referring to FIG. 9, the antenna system has a similar structure as the embodiment shown in FIG. 7. That is, the antenna system includes a first antenna 901, a second antenna 902, a third antenna 903 and a fourth antenna 904, a switch module 900. The switch module 900 selectively connects any one of the first antenna 901, the second antenna 902, the third antenna 903 and the fourth antenna 904 to a transmitter port 905; and selectively connects the first antenna 901, the second antenna 902, the third antenna 903 and the fourth antenna 904 to a first receiver port 906, a second receiver port 907 and a third receiver port 908. In this embodiment, the transmitter port 905 is used as the first port; and the first receiver port 906, the second receiver port 907 and the third receiver port 908 are used as the second port. The transmitter port 905 is connected to both a transmitter and a receiver in the transceiver. Each of the first receiver port 906, the second receiver port 907 and the third receiver port 908 is connected to the receiver in the transceiver.

In an embodiment, the switch module 900 may include a single pole four throw (SP4T) switch 1SW1 and three single pole double throw (SPDT) switches 1SW2, 1SW3 and 1SW4. The SP4T switch 1SW1 has an input terminal connected to the first antenna 901. The SP4T switch 1SW1 includes a switch 1SW11 connecting the input terminal to the transmitter port 905, a switch 1SW12 connecting the input terminal to the first receiver port 906, a switch 1SW13 connecting the input terminal to the second receiver port 907, and a switch 1SW14 connecting the input terminal to the third receiver port 908. In this way, the first antenna 901 may be selectively connected to one of the transmitter port 905, the first receiver port 906, the second receiver port 907 and the third receiver port 908 by the SP4T switch 1SW1.

The SPDT switches include a first SPDT switch 1SW2, a second SPDT switch 1SW3, and a third SPDT switch 1SW4. The first SPDT switch 1SW2 has an input terminal connected to the second antenna 902. The first SPDT switch 1SW2 includes a switch 1SW21 connecting the input terminal to the transmitter port 905, and a switch 1SW22 connecting the input terminal to the first receiver port 906. The second SPDT switch 1SW3 has an input terminal connected to the third antenna 903. The second SPDT switch 1SW3 includes a switch 1SW31 connecting the input terminal to the transmitter port 905, and a switch 1SW32 connecting the input terminal to the second receiver port 907. The third SPDT switch 1SW4 has an input terminal connected to the fourth antenna 904. The third SPDT switch 1SW4 includes a switch 1SW41 connecting the input terminal to the transmitter port 905, and a switch 1SW42 connecting the input terminal to the third receiver port 908.

On/off state of each switch of the switch module 900 is shown in a table 1, when the transmitter port 905 is connected the first antenna 901, the second antenna 902, the third antenna 903 or the fourth antenna 904.

TABLE 1

Transmitter port is connected to

| | First | Second | Third | Fourth |
|---|---|---|---|---|
| | antenna | antenna | antenna | antenna |
| 1SW11 | ON | OFF | OFF | OFF |
| 1SW12 | OFF | ON | OFF | OFF |
| 1SW13 | OFF | OFF | ON | OFF |
| 1SW14 | OFF | OFF | OFF | ON |
| 1SW21 | OFF | ON | OFF | OFF |
| 1SW22 | ON | OFF | ON | ON |
| 1SW31 | OFF | OFF | ON | OFF |
| 1SW33 | ON | ON | OFF | ON |
| 1SW41 | OFF | OFF | OFF | ON |
| 1SW44 | ON | ON | ON | OFF |

Based on the above table 1, each of the first antenna 901, the second antenna 902, the third antenna 903 and the fourth antenna 904 can be selectively connected to the transmitter port 905 by controlling the on/off state of each switch of the switch module 900. Thus, a good communication quality can be obtained in all directions, such that the quality of wireless communication does not depend on the locations and directions of the user and the mobile device.

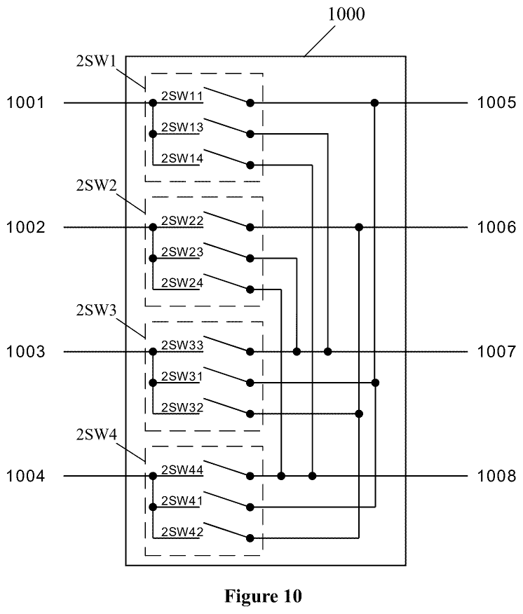

FIG. 10 is a diagram of a structure of a switch module according to another embodiment of the present disclosure. In an embodiment, it is assumed that the number of antennas is M, the number of receiver ports is N, and the number of transmitter port is K, wherein M is an integer larger than or equal to 2, N is an integer larger than or equal to 2, K is larger than or equal to 2, and the number of receiver ports is equal to or larger than the number of the transmitter port. In this case, the above antenna module may include: K sets of single pole (N−K+1) throw switches; and (M−K) sets of single pole (K+1) throw switches.

Both the single pole (N-K+1) throw switches and the single pole (K+1) throw switches include input terminals connected to respective antennas. In addition, each set of the single pole (N-K+1) throw switches includes output terminals respectively connected to one of the transmitter ports and the multiple receiver ports. Each set of the single pole (K+1) throw switches includes output terminals respectively connected to all transmitter ports and one of the multiple receiver ports.

Each antenna can be selectively connected to any transmitter port through the switch module according to the embodiments of the present disclosure. Thus, a good communication quality can be obtained in all directions, such that the quality of wireless communication does not depend on the locations and directions of the user and the mobile device.

In an implementation, referring to FIG. 10, an antenna system includes a first antenna 1001, a second antenna 1002, a third antenna 1003, a fourth antenna 1004, and a switch module 1000. In addition, a transceiver includes two transmitter ports 1005 and 1006 and two receiver ports 1007 and 1008. In this embodiment, the transmitter port 1005 and 1006 are used as the first port; and the receiver ports 1007 and 1008 are used as the second port. The switch module 1000 selectively connects any one of the first antenna 1001, the second antenna 1002, the third antenna 1003 and the fourth antenna 1004 to each of a first transmitter port 1005 and a second transmitter port 1006; and selectively connects the first antenna 1001, the second antenna 1002, the third antenna 1003 and the fourth antenna 1004 to a first receiver port 1007 and a second receiver port 1008.

In an embodiment, the switch module 1000 may include four single pole three throw (SP3T) switches. i.e., a first SP3T switch 2SW1, a second SP3T switch 2SW2, a third SP3T switch 2SW3, and a fourth SP3T switch 2SW4. The first SP3T switch 2SW1 has an input terminal connected to the first antenna 1001. The first SP3T switch 2SW1 includes a switch 2SW11 connecting the input terminal to the first transmitter port 1005, a switch 2SW13 connecting the input terminal to the first receiver port 1007, a switch 2SW14 connecting the input terminal to the second receiver port 1008. The second SP3T switch 2SW2 has an input terminal connected to the second antenna 1002. The second SP3T switch 2SW2 includes a switch 2SW22 connecting the input terminal to the second transmitter port 1006, a switch 2SW23 connecting the input terminal to the first receiver port 1007, and a switch 2SW24 connecting the input terminal to the second receiver port 1008. The third SP3T switch 2SW3 has an input terminal connected to the third antenna 1003. The third SP3T switch 2SW3 includes a switch 2SW33 connecting the input terminal to the first receiver port 1007, a switch 2SW31 connecting the input terminal to the first transmitter port 1005, and a switch 2SW32 connecting the input terminal to the second transmitter port 1006. The fourth SP3T switch 2SW4 has an input terminal connected to the fourth antenna 1004. The fourth SP3T switch 2SW4 includes a switch 2SW44 connecting the input terminal to the second receiver port 1008, a switch 2SW41 connecting the input terminal to the first transmitter port 1005, and a switch 2SW42 connecting the input terminal to the second transmitter port 1006.

On/off state of each switch of the switch module 1000 is shown in table 2, when the transmitter port 1005 is connected the first antenna 1001, the second antenna 1002, the third antenna 1003 and the fourth antenna 1004 respectively.

TABLE 2

| | First transmitter port and second transmitter port | | | | | |
|---|---|---|---|---|---|---|
| | are connected to | | | | | |
| | First | First | First | Second | Second | Third |
| | antenna | antenna | antenna | antenna | antenna | antenna |
| | & | & | & | & | & | & |
| | Second | Third | Fourth | Third | Fourth | Fourth |
| | antenna | antenna | antenna | antenna | antenna | antenna |
| 2SW11 | ON | ON | ON | OFF | OFF | OFF |
| 2SW13 | OFF | OFF | OFF | ON | OFF | ON |
| 2SW14 | OFF | OFF | OFF | OFF | ON | OFF |
| 2SW22 | ON | OFF | OFF | ON | ON | OFF |
| 2SW23 | OFF | ON | OFF | OFF | OFF | OFF |
| 2SW24 | OFF | OFF | ON | OFF | OFF | ON |
| 2SW31 | OFF | OFF | OFF | ON | OFF | ON |
| 2SW32 | OFF | ON | OFF | OFF | OFF | OFF |
| 2SW33 | ON | OFF | ON | OFF | ON | OFF |
| 2SW41 | OFF | OFF | OFF | OFF | ON | OFF |
| 2SW42 | OFF | OFF | ON | OFF | OFF | ON |
| 2SW44 | ON | ON | OFF | ON | OFF | OFF |

Based on the above table 2, each of the first antenna 1001, the second antenna 1002, the third antenna 1003 and the fourth antenna 1004 can be selectively connected to one of the first transmitter port 1005 and the second transmitter port 1006 by controlling the on/off state of each switch of the switch module 1000. Thus, a good communication quality can be obtained in all directions, such that the quality of wireless communication does not depend on the locations and directions of the user and the mobile device.

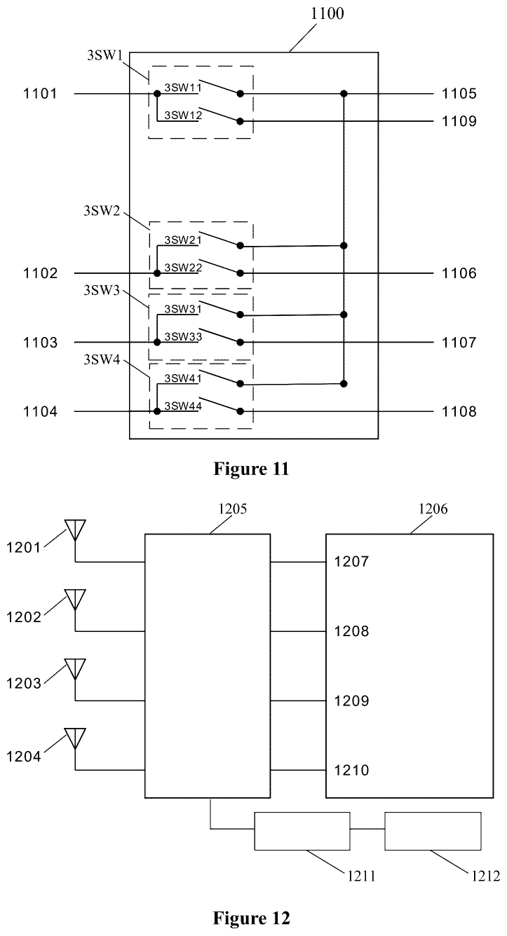

In another embodiment, the switch module may be used as a duplexer. FIG. 11 is a diagram of a switch module in time domain technology according to an embodiment of the present disclosure. In an embodiment, it is assumed that the number of antennas is M, wherein M is an integer larger than or equal to 2, and the electronic wearable device include one transmitter port and multiple receiver ports. In this case, the above antenna module, which functions as the duplexer, may include: M single pole double throw switches.

Each of the SPDT switches includes an input terminal connected to a respective antenna, and two output terminals respectively connected to the transmitter port and one of receiver ports. In this way, each antenna may be selectively connected to the transmitter port by controlling the SPDT switches in the on or off state.

In an implementation, referring to FIG. 11, the antenna system is operated in the time domain technology, such as WiFi protocol. The antenna system includes a first antenna 1101, a second antenna 1102, a third antenna 1103, a fourth antenna 1104, and a switch module 1100. In addition, the transceiver includes one transmitter port 1105, and four receiver ports 1106, 1107, 1108 and 1109. The switch module 1100 selectively connects each of antennas to a transmitter port 1105, and selectively connects antennas to a first receiver port 1106, a second receiver port 1107, and a third receiver port 1108.

The switch module 1100 may include four SPDT switches, i.e., a first SPDT switch 3SW1, a second SPDT switch 3SW2, a third SPDT switch 3SW3, and a fourth SPDT 3SW4. The first SPDT switch 3SW1 has an input terminal connected to a first antenna 1101. The first SPDT switch 3SW1 includes a switch 3SW11 connecting the input terminal to the transmitter port 1105, and a switch 3SW12 connecting the input terminal to the fourth receiver port 1109. The second SPDT switch 3SW2 has an input terminal connected to a second antenna 1102. The second SPDT switch 3SW2 includes a switch 3SW21 connecting the input terminal to the transmitter port 1105, and a switch 3SW22 connecting the input terminal to the first receiver port 1106. The third SPDT switch 3SW3 has an input terminal connected to a third antenna 1103. The third SPDT switch 3SW3 includes a switch 3SW31 connecting the input terminal to the transmitter port 1105, and a switch 3SW32 connecting the input terminal to the second receiver port 1107. The fourth SPDT switch 3SW4 has an input terminal connected to a fourth antenna 1104. The fourth SPDT switch 3SW4 includes a switch 3SW41 connecting the input terminal to the transmitter port 1105, and a switch 3SW42 connecting the input terminal to the third receiver port 1108.

When the switch module is operated in the time domain manner, the on/off state of each switch may be described as follows. When the first antenna 1101 is used for transmitting the RF signal, the switch 3SW11 is on and the switch 3SW12 is off. That is, the first antenna 1101 is connected to the transmitter port 1105 to transmit the RF signals. When the first antenna 1101 is used for receiving the RF signal, the switch 3SW11 is off and the switch 3SW12 is on. That is, the first antenna 1101 is connected to the fourth receiver port 1109 to receive the RF signals. When the second antenna 1102 is used for transmitting the RF signal, the switch 3SW21 is on and the switch 3SW22 is off. That is, the second antenna 1102 is connected to the transmitter port 1105 to transmit the RF signals. When the second antenna 1102 is used for receiving the RF signal, the switch 3SW21 is off and the switch 3SW22 is on. That is, the second antenna 1102 is connected to the first receiver port 1106 to receive the RF signals. When the third antenna 1103 is used for transmitting the RF signal, the switch 3SW31 is on and the switch 3SW32 is off. That is, the third antenna 1103 is connected to the transmitter port 1105 to transmit the RF signals. When the third antenna 1103 is used for receiving the RF signal, the switch 3SW31 is off and the switch 3SW32 is on. That is, the third antenna 1103 is connected to the second receiver port 1107 to receive the RF signals. When the fourth antenna 1104 is used for transmitting the signal, the switch 3SW41 is on and the switch 3SW42 is off. That is, the fourth antenna 1104 is connected to the transmitter port 1105 to transmit the RF signals. When the fourth antenna 1104 is used for receiving the signal, the switch 3SW41 is off and the switch 3SW42 is on. That is, the fourth antenna 1104 is connected to the third receiver port 1108 to receive the RF signals.

Each of the antennas 1101, 1102, 1103 and 1104 may be selectively connected to the transmitter port 1105 by controlling the on/off state of each of the SPDT switches 3SW1, 3SW2, 3SW3 and 3SW4. Thus, a good communication quality can be obtained in all directions, such that the quality of wireless communication does not depend on the locations and directions of the user and the mobile device.

In an embodiment of the present disclosure, the switch module may be implemented in various manners. For example, the switch module may be implemented by a semiconductor or a micro electromechanical system, which will not be limited herein.

FIG. 12 is a diagram of an electronic wearable device according to an embodiment of the present disclosure. Referring to FIG. 12, the electronic wearable device may include: a transceiver 1206 and an antenna system. The transceiver 1206 includes at least one first port 1207, and multiple second ports 1208, 1209, 1210. The antenna system includes: multiple antennas 1201, 1202, 1203, 1204 and a switch module 1205. The switch module 1205 is configured to selectively connect the antennas 1201, 1202, 1203, 1204 to the first port 1207 and the second ports 1208, 1209, 1210 of the transceiver 1206. The first port 1207 is connected to both a transmitter and a receiver in the transceiver 1206, and each of the second ports 1208, 1209, 1210 is connected to the receiver in the transceiver 1206. Each of the antennas 1201, 1202, 1203, 1204 is selectively connected to the at least one first port 1207 via the switch module 1205 to receive and transmit wireless signals. Each of the antennas 1201, 1202, 1203, 1204 is selectively connected to at least one of the second ports 1208, 1209, 1210 via the switch module 1205 to receive wireless signals.

In an embodiment, the electronic wearable device may further include: a controller 1211. The controller 1211 may measure receiver levels of the antennas 1201, 1202, 1203, 1204, determine a best receiver level from the measured receiver levels of the antennas, and control the switch module to connect an antenna with the best receive level to the first port.

In this way, the controller monitors the receiver levels of respective antennas, and compares the receiver levels of respective antennas. The direction of the base station can be estimated based on the compared result. Thus, the control may control the switch module to connect an appropriate antenna. i.e., the antenna with the best receiver level, to the first port.

In an embodiment, the controller is further configured to measure the receiver levels of the multiple antennas 1201, 1202, 1203, 1204 in a preset time interval. Alternatively, the controller is further configured to receive a trigger signal from a sensor 1212, and measure receiver levels of the multiple antennas 1201, 1202, 1203, 1204 in response to the trigger signal.

The receiver levels of the antennas 1201, 1202, 1203, 1204 may be receiver signal strength indicators of the antennas 1201, 1202, 1203, 1204.

In an embodiment, the sensor 1212 may be a motion sensor. In this case, the trigger signal is generated by the motion sensor based on a motion of the electronic wearable device.

The motion sensor may include at least one of an accelerometer, a gyroscope and a compass.

In an embodiment, the motion sensor 1212 is configured to provide the trigger signal to the controller in response to the electronic wearable device being turned a preset angle. The preset angle may be 180 degrees. That is, when detecting that the electronic wearable device turns 180 degrees, the motion sensor sends a trigger signal to the controller. The controller determines the appropriate antenna in response to the trigger signal and controls the switch module to connect the determined antenna to the first port.

In an embodiment, the sensor 1212 may include a position sensor. The trigger signal is generated by the position sensor based on a position of an electronic wearable device.

Thus, the position and direction of the electronic wearable device may be monitored by the above motion sensor and the position sensor, so as to trigger the estimation of the appropriate antenna. In this way, the antenna with the best communication quality may be selected to be connected with the first port, to further improve the communication quality of the electronic wearable device.

In an embodiment, the controller is further configured to compare the receiver level of the current antenna with a receiver level of a currently measured antenna to obtain a compared result; determine that the compared result is larger than a threshold; and control the switch module to connect the current measured antenna to the transmitter port. Thus, a frequently switching of the antennas can be avoided by setting the threshold.

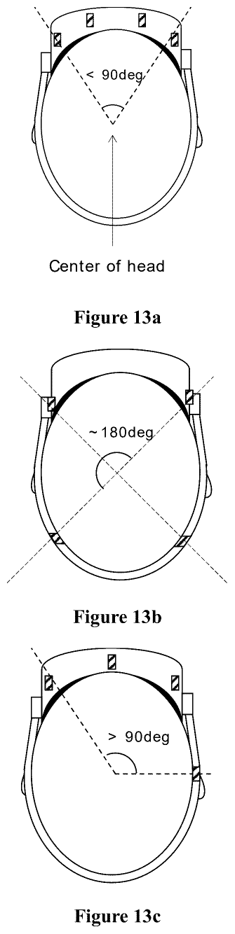

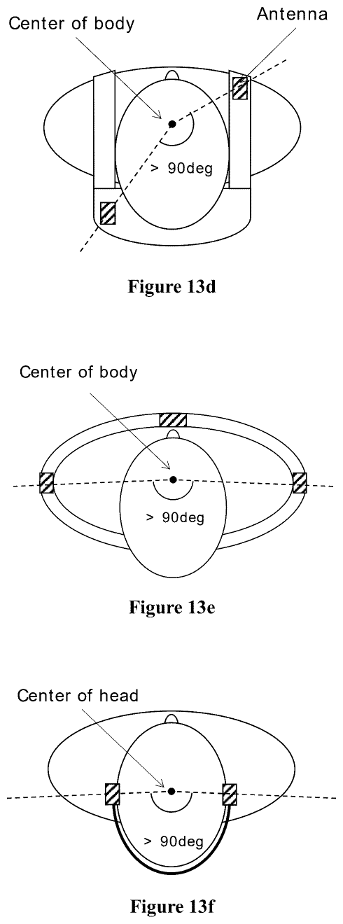

FIGS. 13a-13f are diagrams of examples of an electronic wearable device according to an embodiment of the present disclosure. In FIGS. 13a-13c, it is taken smart glasses with four antennas as an example. It should be noted that the smart glasses may be, but is not limited to, an augmented reality glasses or a virtual reality glasses. The antennas are arranged in a preset distance on the smart glass. In FIG. 13a, all antennas are arranged in a side of the body of the user. For example, four antennas are all arranged in front of the head of the user. In this case, orthographic projections of two arbitrary antennas on a horizontal plane and an orthographic projection of a center of a body of a user on the horizontal plane form an angle. The angle in FIG. 13a is less than 90 degrees. When the antennas are switched by the switch module as described in the above embodiments, it is difficult to cover all directions around the user. Thus, the wireless communication quality of the electronic wearable device with the switch module according to the above embodiment is not good enough.

In FIG. 13b, the four antennas are evenly arranged around the head of the user. In this case, the angle, which is formed by the orthographic projections of two arbitrary antennas on a horizontal plane and an orthographic projection of a center of a body of a user on the horizontal plane, has a maximum approximately 180 degrees. Thus, the antennas can cover all directions around the user by the switching of the switch module. The electronic wearable device has good quality of the wireless communication in any direction thereof.

Actually, as shown in FIG. 13c, when the angle has the maximum larger than 90 degrees, the quality of the wireless communication of the electronic wearable device is good enough.

In FIG. 13d, a smart backpack with two antennas is taken as an example. The antennas are respectively arranged at a belt and a main compartment of the backpack. The angle, which is formed by the orthographic projections of two antennas on a horizontal plane and an orthographic projection of a center of a body of a user on the horizontal plane, is larger than 90 degrees. Thus, a good quality of the wireless communication can be obtained.

In FIG. 13e, a smart belt with three antennas is taken as an example. The antennas are arranged at two sides and in front of the body of the user. The angle, which is formed by the orthographic projections of two antennas on a horizontal plane and an orthographic projection of a center of a body of a user on the horizontal plane, has the maximum larger than 90 degrees. Thus, a good quality of the wireless communication can be obtained.

In FIG. 13f, a wireless headphone or a wireless earphone is taken an example. The wireless headphone or the wireless earphone has earpieces connected electrically, and has two antennas. The two antennas are respectively arranged two sides of the head of the user. The angle, which is formed by the orthographic projections of two antennas on a horizontal plane and an orthographic projection of a center of a body of a user on the horizontal plane, approximates 180 degrees. Thus, a good quality of the wireless communication can be obtained.

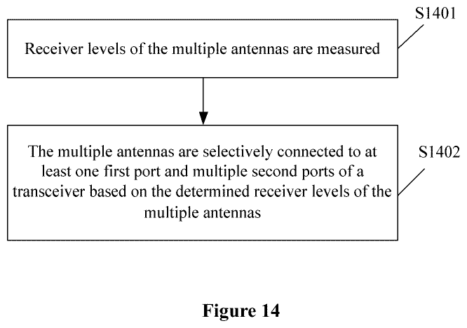

A method for controlling an antenna system is provided according to an embodiment of the present disclosure. FIG. 14 is a flow chart of a method of controlling an antenna system according to an embodiment of the present disclosure. As shown in FIG. 14, the antenna system includes multiple antennas, and the method for controlling the antenna system includes steps S1401 and S1402.

In S1401, receiver levels of the multiple antennas are measured.

In S1402, the multiple antennas are selectively connected to at least one first port and multiple second ports of a transceiver based on the determined receiver levels of the multiple antennas. Each of the multiple antennas is selectively connected to the first port to receive and transmit wireless signals, and each of the plurality of antennas is selectively connected to at least one of the multiple second ports via a switch module to receive wireless signals.

In an embodiment, after receiver levels of the multiple antennas is measured, the best receiver level is determined from the measured receiver levels of the multiple antennas, and the antenna with the best receiver level is determined.

In this case, the step S1402 further includes: connecting the antenna with the best receiver level to the first port.

In the method according to the embodiment of the present disclosure, the antenna with the maximum of the receiver level is connected to the first port by comparing the receiver levels of all antennas, so as to improve a quality of the wireless communication.

In an embodiment, the receiver levels of the multiple antennas include receiver signal strength indicators (RSSIs) of the multiple antennas. That is to say, the antenna with the maximum of the RSSIs is determined to connect to the first port.

In an embodiment, the step 1401 may include: measuring receiver levels of the multiple antennas in a preset time interval.

Alternatively, the step 1401 may include: receiving a trigger signal from a sensor; and measuring receiver levels of the multiple antennas in response to the trigger signal.

In an embodiment, the sensor may be a motion sensor. The trigger signal is generated by the motion sensor based on a motion of an electronic wearable device with the antenna system.

The motion sensor may generate the trigger signal based on a motion of an electronic wearable device with the antenna system. That is, when motion sensor monitors the motion of the electronic wearable device, the receiver levels of the multiple antennas are measured and an appropriate antenna is determined to connect to the first port.

In an embodiment, the trigger signal is generated by the motion sensor in response to the electronic wearable device being turned a preset angle. For example, when the motion sensor monitors that the electronic wearable device turns 180 degrees, the trigger signal is generated. Thus, the antenna with the best quality of the wireless communication is ensured to connect to first port.

The motion sensor may include at least one of an accelerometer, a gyroscope and a compass.

In an embodiment, the sensor may be a position sensor. The trigger signal is generated by the position sensor based on a position of an electronic wearable device with the antenna system.

Thus, the position and direction of the electronic wearable device may be monitored by the above motion sensor and the position sensor, so as to trigger the estimation of the appropriate antenna. In this way, the antenna with the best communication quality may be selected to be connected with the first port, to further improve the communication quality of the electronic wearable device.

In an embodiment, the method of controlling the antenna system may further include: comparing the receiver level of the current antenna with a receiver level of a currently measured antenna to obtain a compared result: determining that the compared result is larger than a threshold; and connecting the current measured antenna to the first port.

For example, it is assumed that the threshold is equal to 3 dBm, and the first antenna is used as the current antenna which is connected to the first port. When the RSSI of the first antenna is equal to −60 dBm and the RSSI of the second antenna is equal to −59 dBm, the first antenna is kept to connect to the first port. When the RSSI of the first antenna is measured to be −60 dBm and the RSSI of the second antenna is measured to be −56 dBm, the different between the RSSI of the first antenna and the RSSI of the second antenna is larger than the threshold. In this case, the second antenna is connected to the first port. Thus, a frequently switching of the antennas can be avoided by setting the threshold.

In an embodiment of the present disclosure, a non-transitory computer readable storage medium storing computer instructions is further provided. The computer instructions are used to cause a computer to perform the method for controlling the antenna system according to the foregoing method embodiments.

A computer program product is further provided according to an embodiment of the present disclosure. The computer program product includes a computer program stored on a non-transitory computer readable storage medium. The computer program includes program instructions that, when executed by a computer, cause the computer to perform the method for controlling the antenna system according to the foregoing method embodiments. A computer program is provided according to an embodiment of the present disclosure. The computer program, when executed by a computer, causes the computer to perform the method for controlling the antenna system according to the foregoing method embodiments.

The electronic wearable device according to the embodiments of the present disclosure may include, but is not limited to, a smart glass, a smart backpack, a smart belt, a wireless headphone and a wireless earphone having earpieces connected electrically and other wearable mobile terminals. The electronic wearable device is only exemplary, and should not indicate any limitation to the function and scope of application of the embodiments of the present disclosure.

The electronic device may include a processing apparatus, such as a central processing unit (CPU) or a graphics processor, which may execute various operations and processing based on a program stored in a read only memory (ROM) or a program loaded from a storage apparatus into a random access memory (RAM). The RAM is further configured to store various programs and data required by the electronic device to perform an operation. The processing apparatus, the ROM and the RAM are connected to each other through a bus. An input/output (I/O) interface is also connected to the bus.

Particularly: according to the embodiments of the present disclosure, the processes described above with reference to flowcharts may be implemented as a computer software program. For example, a computer program product is further provided as an embodiment in the present disclosure, including a computer program carried on a computer readable medium. The computer program includes program code for performing the method shown in the flowchart. In the embodiment, the computer program may be downloaded and installed from the network via the communication apparatus, or installed from the storage apparatus, or installed from the ROM. When the computer program is executed by the processing apparatus, the functions defined in the method according to the embodiment of the present disclosure are performed.

It is to be noted that the computer readable medium mentioned herein may be a computer readable signal medium or a computer readable storage medium or any combination thereof. The computer readable storage medium may be but is not limited to, a system, an apparatus, or a device in an electronic, magnetic, optical, electromagnetic, infrared, or semi-conductive form, or any combination thereof. The computer readable storage medium may be, but is not limited to, an electrical connection with one or more wires, a portable computer disk, a hard disk, a random access memory (RAM), a read only memory (ROM), an erasable programmable read only memory (EPROM or flash memory), an optical fiber, a portable compact disc read only memory (CD-ROM), a light storage device, a magnetic storage device or any proper combination thereof. In the present disclosure, the computer readable storage medium may be any tangible medium containing or storing a program, and the program may be used by or in combination with an instruction execution system, apparatus, or device. In the present disclosure, the computer readable signal medium may be a data signal transmitted in a baseband or transmitted as a part of a carrier wave and carrying computer readable program codes. The transmitted data signal may be in various forms, including but not limited to an electromagnetic signal, an optical signal or any proper combination thereof. The computer readable signal medium may be any computer readable medium other than the computer readable storage medium, and may send, propagate or transmit programs to be used by or in combination with an instruction execution system, apparatus or device. The program codes stored in the computer readable medium may be transmitted via any proper medium including but not limited to: a wire, an optical cable, radio frequency (RF) and the like, or any proper combination thereof.

The computer readable medium may be incorporated in the electronic device, or may exist alone without being assembled into the electronic device.

The computer readable medium carries one or more programs. The one or more programs, when executed by the electronic device, cause the electronic device to: measuring receiver levels of the multiple antennas; and selectively connecting the multiple antennas to at least one first port and multiple second ports of a transceiver based on the determined receiver levels of the multiple antennas, wherein each of the multiple antennas is selectively connected to the first port to receive and transmit wireless signals, and each of the plurality of antennas is selectively connected to at least one of the multiple second ports via a switch module to receive wireless signals.

Flowcharts and block diagrams in the drawings illustrate the architecture, functions and operations that may be implemented by the system, method and computer program produce according to the embodiments of the present disclosure. In this regard, each block in the flowcharts or the block diagrams may represent a module, a program segment, or a part of code. The module, the program segment, or the part of code contains one or more executable instructions for implementing the specified logical function. It should be also noted that, in some alternative implementations, the functions shown in the blocks may be performed in an order different from the order shown in the drawings. It should also be noted that, each block in the block diagrams and/or the flowcharts and a combination of blocks in the block diagrams and/or the flowcharts may be implemented by a dedicated hardware-based system performing specified functions or operations, or may be implemented by a combination of dedicated hardware and computer instructions.

According to the description of the disclosed embodiments, those skilled in the art can implement or use the present disclosure. Various modifications made to these embodiments may be obvious to those skilled in the art, and the general principle defined herein may be implemented in other embodiments without departing from the scope of the present disclosure. Therefore, the present disclosure is not limited to the embodiments described herein but confirms to a widest scope in accordance with principles and novel features disclosed in the present disclosure.

1. An antenna system, comprising:
a plurality of antennas; and
a switch module configured to selectively connect the plurality of antennas to at least one first port and to at least one of a plurality of second ports of a transceiver,
wherein each of the plurality of antennas is selectively connected to the at least one first port via the switch module to receive and transmit wireless signals, and each of the plurality of antennas is selectively connected to at least one of the plurality of second ports via the switch module to receive the wireless signals.

2. The antenna system according to claim 1, wherein the at least one first port comprises K first port(s), the plurality second ports comprises N second ports, wherein K is larger than N, the plurality of antennas comprises M antennas, wherein M is an integer larger than or equal to 2, N is an integer larger than or equal to 2, and K is an integer larger than or equal to 1.

3. The antenna system according to claim 2, wherein when K is equal to 1, the switch module comprises:
one set of single pole N throw switch, and
(M−1) set of single pole double throw switches,
wherein the set of single pole N throw switch comprises output terminals respectively connected to the first port and the plurality of second ports; and
each set of the single pole double throw switches comprises output terminals respectively connected to the first port and one of the plurality of second ports.

4. The antenna system according to claim 2, wherein when K is equal to or larger than 2, the switch module comprises:
K sets of single pole (N−K+1) throw switches, and
(M−K) sets of single pole (K+1) throw switches,
wherein each set of the single pole (N−K+1) throw switches comprises output terminals respectively connected to one of the first ports and the plurality of second ports; and
each set of the single pole (K+1) throw switches comprises output terminals respectively connected to the first ports and one of the plurality of second ports.

5. The antenna system according to claim 2, wherein the switch module comprises: M single pole double throw switches,
wherein each of the single pole double throw switches comprises two output terminals respectively connected to the first port and one of the plurality of second ports.

6. The antenna system according to claim 1, wherein orthographic projections of two arbitrary antennas on a horizontal plane and an orthographic projection of a center of a body of a user on the horizontal plane form an angle, having a maximum of value larger than 90 degrees.

7. The antenna system according to claim 1, wherein the switch module includes a semiconductor switch or a micro electromechanical system.

8. An electronic wearable device, comprising:
a transceiver comprising at least one first port and a plurality of second ports, wherein the at least one first port is connected to both a transmitter and a receiver in the transceiver, and each of the plurality of second ports is connected to the receiver in the transceiver:
an antenna system, comprsing:
a plurality of antennas; and
a switch module configured to selectively connect the plurality of antennas to the at least one first port and the plurality of second ports of the transceiver,
wherein each of the plurality of antennas is selectively connected to the first port via the switch module to receive and transmit wireless signals, and to each of the plurality of antennas is selectively connected to at least one of the plurality of second ports via the switch module to receive the wireless signals.

9. The electronic wearable device according to claim 8, further comprises:
a controller configured to measure receiver levels of the plurality of antennas, determine a highest receiver level from the measured receiver levels of the plurality of antennas, and control the switch module to connect an antenna with a highest receive level to the first port.

10. The electronic wearable device according to claim 9, wherein the controller is further configured to measure the receiver levels of the plurality of antennas in a preset time interval.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A method for controlling an antenna system having a plurality of antennas, comprising:
measuring receiver levels of the plurality of antennas; and
selectively connecting the plurality of antennas to at least one first port and to a plurality of second ports of a transceiver based on a determined receiver levels of the plurality of antennas, wherein each of the plurality of antennas is selectively connected to the first port to receive and transmit wireless signals, and each of the plurality of antennas is selectively connected to at least one of the plurality of second ports via a switch module to receive the wireless signals.

26. The method according to claim 25, wherein after measuring receiver levels of the plurality of antennas, the method further comprises:
determining a highest receiver level from the measured receiver levels of the plurality of antennas, and
the selectively connecting the plurality of antennas to at least one first port and a plurality of second ports of a transceiver based on the determined receiver levels of the plurality of antennas comprises:
connecting one of the antennas with the highest receiver level to the first port.

27. The method according to claim 25, wherein the measuring receiver levels of the plurality of antennas comprises:
measuring receiver levels of the plurality of antennas in a preset time interval.

28. The method according to claim 25, wherein the measuring receiver levels of the plurality of antennas comprises:
receiving a trigger signal from a sensor; and
measuring receiver levels of the plurality of antennas in response to the trigger signal.

29. The method according to claim 25, wherein the receiver levels of the plurality of antennas comprise receiver signal strength indicators of the plurality of antennas.

30. The method according to claim 28, wherein the sensor comprises a motion sensor, and
the trigger signal is generated by the motion sensor based on a motion of an electronic wearable device with the antenna system.

31. The method according to claim 30, wherein the trigger signal is generated by the motion sensor in response to the electronic wearable device being turned a preset angle.

32. The method according to claim 30, wherein the motion sensor comprises at least one of an accelerometer, a gyroscope, and a compass.

33. The method according to claim 28, wherein the sensor comprises a position sensor, and
the trigger signal is generated by the position sensor based on a position of an electronic wearable device with the antenna system.

34. The method according to claim 26, further comprising:
comparing the receiver level of the current antenna with a receiver level of a currently measured antenna to obtain a compared result;
determining if the compared result is larger than a threshold; and
connecting the current measured antenna to the first port if the threshold is exceeded.
